(19) United States
(12) Patent Application Publication
(10) Pub. No.: US 2026/0117960 A1
(43) Pub. Date: Apr. 30, 2026

(54) ARMBAND SAFETY LIGHTING ON VEHICLE RIDER

(71) Applicant: Admore Lighting Inc., Calgary (CA)

(72) Inventors: David BARTELL, Calgary (CA); Catalin Nicolae PETRESCU, Kanata (CA)

(73) Assignee: Admore Lighting Inc., Calgary (CA)

(21) Appl. No.: 19/424,546

(22) Filed: Dec. 18, 2025

Related U.S. Application Data
(63) Continuation-in-part of application No. 18/410,487, filed on Jan. 11, 2024.

(51) Int. Cl. F21V 21/08; F21V 23/04

(52) U.S. Cl. CPC F21V 21/0816; F21V 23/0435

(57) ABSTRACT

A vehicle safety lighting system includes: a wireless control device comprising a controller and wireless transceiver, the wireless control device configured to receive brake, left and right turn signals from a vehicle; and left and right armbands for an operator of the vehicle, each armband comprising a Light Emitting Array (LEA) and a wireless transceiver. Each armband is configured to receive a control signal from the wireless control device, the control signal causing the LEA of the armband to output a visual signal coordinated with the brake, left or right turn signals of the vehicle.

### CROSS REFERENCE TO RELATED APPLICATIONS

This application is a Continuation-in-Part of U.S. patent application Ser. No. 18/410,487, entitled “ARMBAND SAFETY LIGHTING ON VEHICLE RIDER,” filed Jan. 11, 2024, the entire contents of which is hereby expressly incorporated herein by reference, and from which priority and the benefit of the filing date is claimed.

### BACKGROUND

Motor vehicles have safety lighting to indicate the presence of the vehicle, to help the driver see the road ahead in low-light conditions and also to communicate to other drivers the actions and anticipated actions of the driver. Safety lighting includes headlights, tail lights, and turn signal lights

In particular, the brake lights of a vehicle are visible from the rear of the vehicle to alert motorists behind the vehicle that the vehicle is braking. These brake lights are activated in response to the vehicle operator applying manual force to the vehicle's brake actuator(s), for example, the operator depressing the brake pedal or, for motorcycles, the rider/operator squeezing the hand brake lever or pressing the foot pedal. The brake lights thereby give drivers behind the vehicle immediate, attention-grabbing notice of the vehicle deceleration due to the operation of friction braking. The drivers behind the vehicle therefore have a warning to adjust their speed, e.g., apply their own brakes, to avoid colliding with the operator's vehicle.

Similarly, turn signals on a vehicle provide a lighting system that allows the vehicle operator to give notice and warning to other drivers when they are making a right or left turn or are changing lanes or are pulling into or out of traffic. Like brake lights, these turn signals allow other drivers to react appropriately to avoid a collision.

Any mechanism for more prominently and effectively signaling what a vehicle is doing, or is about to do, to other drivers can help avoid collisions and promote safety for both drivers and bystanders. Consequently, technological advances have been made to expand and enhance the ability of vehicle systems to communicate a driver's intentions or the vehicle's behavior to other drivers.

In one general aspect, the following description presents a vehicle safety lighting system includes: a wireless control device comprising a controller and wireless transceiver, the wireless control device configured to receive brake, left and right turn signals from a vehicle; and left and right armbands for an operator of the vehicle, each armband comprising a Light Emitting Array (LEA) and a wireless transceiver. Each armband is configured to receive a control signal from the wireless control device, the control signal causing the LEA of the armband to output a visual signal coordinated with the brake, left or right turn signals of the vehicle.

In another general aspect, the following description presents a method of vehicle safety lighting, the method including: receiving, via a wireless control device, brake, left and right turn signals from a vehicle, the wireless control device comprising a controller and wireless transceiver; transmitting, via the wireless control device, a control signal to each of left and right armbands worn by an operator of the vehicle, each armband comprising a Light Emitting Array (LEA) and a wireless transceiver; and outputting, based on the control signal, a visual signal with the LEAs. The visual signal is coordinated with the brake, left or right turn signals of the vehicle.

In another general aspect, the following description describes a vehicle safety lighting system that includes: a Bluetooth® control device comprising a controller and Bluetooth® wireless transceiver, the Bluetooth® control device configured to receive brake, left and right turn signals from a vehicle; and two armbands for an operator of the vehicle, each armband comprising a Light Emitting Array (LEA) and a Bluetooth® wireless transceiver. Each armband is configured to receive a control signal from the Bluetooth® wireless control device, the control signal causing the LEA of the armband to output a visual signal coordinated with the brake, left or right turn signals of the vehicle. Each armband has a designation stored in the system as being a left or right armband.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1A shows a front cross-sectional view of an exemplary implementation of a vehicle safety lighting system according to various aspects of the disclosure.

FIG. 1B is a top elevation view, from the FIG. 1A projection 1-1, showing one exemplary Light Emitting Array (LEA) of, for example, light emitting diodes (LEDs) in one implementation of a vehicle safety lighting system according to various aspects.

FIG. 1C is a bottom elevation view, from the FIG. 1A projection 2-2, showing one exemplary configuration of circuitry components for controlling the LEA, in one implementation of a vehicle safety lighting system according to various aspects.

FIG. 2 shows an LEA support surface of an exemplary substrate of an implementation according to FIGS. 1A-1C, without the LEA, annotated to illustrate a left array area and a right array area, in one implementation of a vehicle safety lighting system according to various aspects.

FIG. 3 shows an exemplary array configuration, on the FIG. 2 arrangement of the support surface, in one implementation of a vehicle safety lighting system according to various aspects.

FIG. 4 shows an exemplary implementation of a vehicle safety lighting system according to various aspects, in a combination with a cable for coupling to vehicle power and vehicle control signals.

FIG. 5A illustrates an example of additional vehicle safety lighting provided on armbands to be worn by an operator of a vehicle, such as a motorcycle or scooter according to principles described herein.

FIG. 5B illustrates an example of a system supporting the vehicle safety light armbands of FIG. 5A according to principles described herein.

FIG. 5C illustrates other details of an example of a system supporting the vehicle safety light armbands of FIG. 5A according to principles described herein.

FIG. 5D is a flowchart illustrating an example of a method of operating a system supporting the vehicle safety light armbands of FIG. 5A according to principles described herein.

FIG. 6 is a flowchart illustrating additional details of a method of operating a safety lighting system including the armbands as described herein.

FIG. 7 is a flowchart illustrating additional details of a method of operating a safety lighting system including the armbands as described herein.

FIG. 8 is a block diagram of an example of a safety lighting system armband as described herein.

FIG. 9 is a block diagram of an example rear-approach detection and warning subsystem as described herein.

### DETAILED DESCRIPTION

As noted above, any mechanism for more prominently and effectively signaling what a vehicle is doing or is about to do to other drivers can help avoid collisions and promote safety for both drivers and bystanders. Consequently, technological advances have been made to expand and enhance the ability of vehicle systems to communicate a driver's intentions or the vehicle's behavior to other drivers.

For example, U.S. Pat. No. 10,363,865, which is incorporated herein by reference in its entirety, describes the use of a multi-axis accelerometer to detect deceleration of a vehicle that may be due to other factors besides the braking system, such as reducing the engine throttle or down-shifting the transmission to a lower gear. In such cases, by detecting the deceleration independent of the brakes being applied, the system is able to give notice to surrounding drivers, particularly trailing drivers, of that deceleration.

For example, such a system includes a lightbar composed of a support substrate and an array of light emitting elements (LEA), e.g., light emitting diodes (LEDs), mounted on an array support surface of the substrate. The lightbar can be supported in a housing that is configured for mounting to a rear-facing surface of the vehicle, such as a motorcycle, scooter, automobile, or truck.

A controller unit, coupled to the multi-axis accelerometer, is configured to determine vehicle deceleration based at least in part on the plurality of axis measurements. The controller unit can be further configured to detect when the vehicle deceleration exceeds a brake light activation threshold and, based at least in part on the detection, configured to output a brake light activation signal to at least some of the light emitting elements among the array. The controller unit can be configured to generate the brake light activation signal in a form that causes the LEA to light up, including lighting in a sequential pattern or in additional patterns.

The plurality of light emitting elements within the LEA can be of uniform color or can be multi-colored, for example, amber, red, and white. The multi-axis accelerometer can be configured to output the plurality of axis acceleration measurements as analog signals. In such a configuration, the controller unit can include an analog-to-digital (A/D) converter or, as one alternative, a separate A/D can be positioned between the multi-axis accelerometer and the controller unit.

The LEAs described herein can be incorporated into an article of clothing to be worn by the rider or operator of the vehicle. As used herein, the term “clothing” refers to any of armbands, a jacket, a shirt or pants to be worn by the rider or operator of the vehicle.

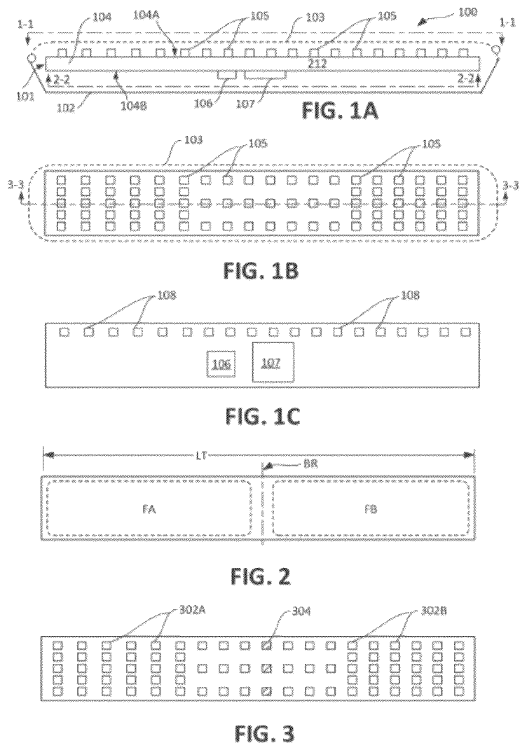

FIG. 1A shows a front, cross-sectional view of one implementation of a vehicle safety lighting system 100 according to one or more aspects of this disclosure. FIG. 1B shows a top projection of the vehicle safety lighting system 100, on the FIG. 1A projection plane 1-1. FIG. 1C shows a bottom projection of the vehicle safety lighting system 100, on the FIG. 1A projection plane 2-2. The FIG. 1A cross-cut projection is the FIG. 1B cross-cut projection plane 3-3.

Referring to FIG. 1A, the vehicle safety lighting system 100 can include a multi-element lightbar 101 supported within a housing 102 and that can be covered with a light cover 103. The light cover 103 can be formed of a clear plastic or a colored translucent plastic. Referring still to FIG. 1A, the multi-element lightbar 101 can include a support substrate 104, for example, a printed circuit board (PCB), having a first surface 104A that faces the light cover 103. The first surface 104A can support an LEA 105. The LEA 105 can be, but is not limited to being, configured as a row-column matrix or other array configuration. The LEA 105 can be implemented as surface mount (SMT) LEDs. The support substrate 104 can provide a second surface 104B, opposite the first surface 104A, that supports circuitry for selectively energizing or activating all of, or regions of, or patterns within the LEA 105.

Referring to FIG. 1C, the system 100 can include a multi-axis accelerometer 106, which can be a portion of the circuitry supported by the second surface 104B. The multi-axis accelerometer 106 can be coupled to a control unit 107, which can also be a portion of the circuitry on the second surface 104B. The control unit 107 can be coupled to the LEA 105, by a coupling that can include, for example, conducting vias (not explicitly visible in FIG. 1A-C) formed in the support substrate 104. In some examples, coupling of the control unit 107 to the LEA 105 can include MOSFET switches, such as the exemplary MOSFET switches 108.

In various examples, the multi-axis accelerometer 106 can be a 3-axis accelerometer, configured to measure acceleration along each of three orthogonal axes. For purposes of description, the three axes can be referred to as the “Z” axis, “X” axis, and “Y” axis. The multi-axis accelerometer 106, in this configuration, can output an Z acceleration measurement, an X acceleration measurement, and a Y acceleration measurement.

In various examples, the housing 102, support substrate 104, and multi-axis accelerometer 106 can be configured such that the Z axis is aligned with a center longitudinal axis of the vehicle. The center longitudinal axis of the vehicle can be co-linear with the direction of the vehicle when traveling straight. The Z axis will be alternatively referred to as the “axial” axis. The above-described configuration of the housing 102, support substrate 104, and multi-axis accelerometer 106 can also align the X axis perpendicular to the Z axis, such that Z and X axes form a plane that, when the vehicle is upright on a zero-incline surface, is normal to the direction of gravity. The X axis will be alternatively referred to as the “lateral” axis. The Y axis can be normal to the X axis and to the Z axis, in a configuration such that the Y axis can align with the direction of gravity when the vehicle is fully upright (e.g., zero lean) on a zero-incline surface.

In various examples, the X, Y, and Z acceleration measurements can be output as continuous analog signals, and the vehicle safety lighting system 100 can include a sampling of the signals. In an example implementation, sampling can be of all three axes, to generate Z, X, and Y acceleration samples, which can be processed, for example, by computational resources of the control unit 107 as will be described in greater detail later in this disclosure. The sampling can be provided, in some examples, by an analog-to-digital (A/D) converter within the control unit 107. In an alternative, the A/D converter can be implemented as a separate device that receives the Z, X, and Y acceleration measurements from the multi-axis accelerometer 106, and feeds corresponding Z, X, and Y acceleration samples to the control unit 107.

It will be understood that the Z (axial), X (lateral), and Y axes of the multi-axis accelerometer 106 are relative to the vehicle. Accordingly, in some examples, the control unit 107 can be configured to apply an axis rotation to acceleration samples along one or more of the axes. In various examples, the axis rotation can be configured to obtain a sequence of corrected Z acceleration samples, indicating a net acceleration vector aligned with the Z or longitudinal axis of the vehicle. Benefits and advantages of the rotation producing the corrected Z acceleration samples can be illustrated by a scenario in which another vehicle is behind the subject vehicle travelling at constant speed, having its longitudinal axis in the same direction, or approximately the same direction as the measured vehicle. In such a scenario, the net acceleration of the measured vehicle in the direction of its longitudinal axis can translate directly to and immediately to rapid changes, e.g., increase or decrease, of the spacing between the rear of that vehicle and the front of the trailing vehicle.

In some examples, the control unit 107 can be configured to compare the sequence of corrected Z acceleration samples to a deceleration threshold and, when the threshold is exceeded, generate a deceleration warning signal. It will be understood that operations of deceleration-based triggering of a brake light illumination from the LEA 105, according to this example, do not require generation of corrected X acceleration samples.

In one alternative implementation, the Y acceleration samples can be omitted, and the above-described rotation that generates the corrected Z acceleration samples can be based only on the Z and X samples. One example of such implementation can include using a two-axis accelerometer as the multi-axis accelerometer 106, providing only Z samples and X samples. Another example implementation can use the above-described 3 axis accelerometer for the multi-axis accelerometer 106, while discarding the Y samples.

In a further implementation, the control unit 107, or another processing resource can be further configured to apply “noise” filtering operations to the Z acceleration measurements, or to the Z and X measurements, or to all of the axis measurements. Features and benefits can include removing “noise” from the Z acceleration measurements, or from the Z and X measurements, or from the Z, X, and Y acceleration samples. In some examples, the noise can be removed by coupling a respective analog filter to one or more outputs of the multi-axis accelerometer 106, e.g., to the Z output, to the Z and X output, or to all of the Z, X and Y outputs. In another aspect, the noise filter or filters can be configured as respective digital low pass filters that, in turn, operate on the digital output from one, or two, or (if three samples are used) to all three. In another aspect, the noise filter(s) can be implemented as a combination one or more of above-described analog filters, and a digital filter for one or more of the sampler outputs. Benefits and advantages of any of these implementations can include a decrease in false alarms arising from events such as the vehicle hitting a pothole. It will be understood, regarding the digital noise filtering, that exemplary implementations can configure such digital filters to operate prior to the above-described axis rotation, or after the axis rotation, or both. The control unit 107 can be configured to generate the deceleration warning signal as a pulse width modulation (PWM), to provide for control of the brightness of the light generated by the LEA 105.

FIG. 2 shows the first surface 104A without the LEA 105. Referring to FIG. 2, the first surface can include a first laterally extending support area, labeled “FA,” and a second laterally extending support area, labeled “FB.” As illustrated, the first surface 104A can have a length LT. In various examples where the vehicle safety lighting system 100 is mounted to a vehicle, LT can extend parallel to the Y axis, i.e., in a lateral or left-to-right direction relative to the vehicle. The LEA may be mounted at various places on the vehicle, facing rearward, such as above or below a license tag, elsewhere on the body of the vehicle, or, in the case of a motorcycle or the like, at the rear of a set of panniers or top case.

For purposes of description, a bisector reference line BR appears on FIG. 2, symmetrical between FA and FB. In various examples where the vehicle safety lighting system 100 is mounted on the rear of a vehicle, the positioning can place the bisector reference line halfway between the left and right of the vehicle. Accordingly, facing toward the rear of the vehicle, FA can be to the left of the vehicle center, and FB can be to the right of the vehicle center. Therefore, for purposes of description, the LEA first and second laterally extending support areas FA, FB will be alternatively referred to as the “left array area” and the “right array area,” respectively. In various examples that mounts the vehicle safety lighting system 100 to the back of a motorcycle, the mounting can align BR with the lateral centerline of the motorcycle. Mounted as such, when viewed from a point facing toward the rear of the motorcycle, the left array area and right array area can be to the left and to the right, respectively, of the motorcycle's lateral centerline.

FIG. 3 shows the above-described FIG. 2 partitioning, with multicolor light emitting elements 302A (e.g., an array, or region of an array of multicolor light emitting elements) in the left array area and multicolor light emitting elements 302B (e.g., another array or another region of an array of multicolor light emitting elements) in the right array area. The multicolor light emitting elements 302A and 302B can be, for example, red/amber light emitting elements. In some examples, white light emitting elements 304 can be positioned between the left array area and the right array area, or substantially aligned with the bisector reference line BR.

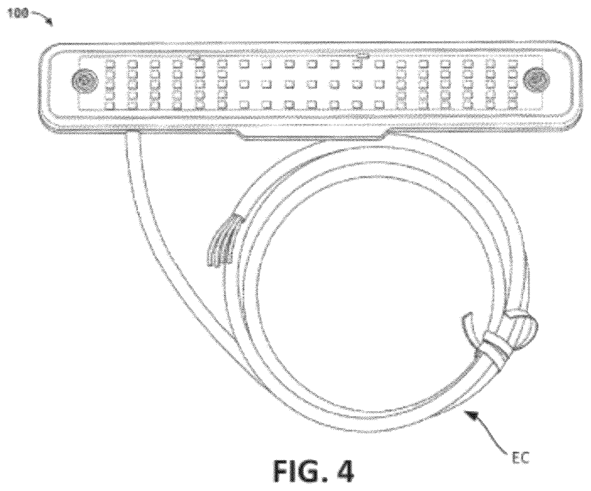

In various examples, the control unit 107 can be configured to receive, from the vehicle, conventional human operator actuated signals, such as a brake signal, left turn signal, and right turn signal. The control unit 107 can be configured to obtain these signals, for example, via a CANBUS-to-SIGNALS interface or via an interface to another control bus of the vehicle. Referring to FIG. 4, such interfacing can include an electrical cable, such as the exemplary cable labeled “EC,” which can also connect the vehicle safety lighting system 100 to a vehicle power supply, for example 12 volts.

In some examples, the vehicle safety lighting system 100 can include a USB, micro-USB or equivalent receptacle/port, and/or include a Bluetooth® or equivalent wireless interface, for user interface to the control unit 107. The user interface can provide the user with capability, for example, of various customization or configuration of the control unit 107, as well as firmware updates. In some examples, a Bluetooth® Low Energy (BLE) Bluetooth® or equivalent wireless interface can be implemented as a Bluetooth® or equivalent “dongle” that can plug into a USB, micro-USB or equivalent receptacle/port.

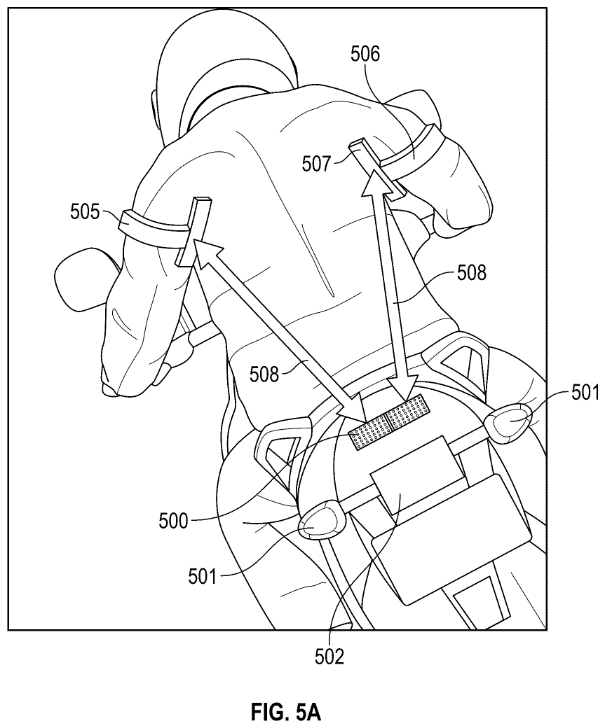

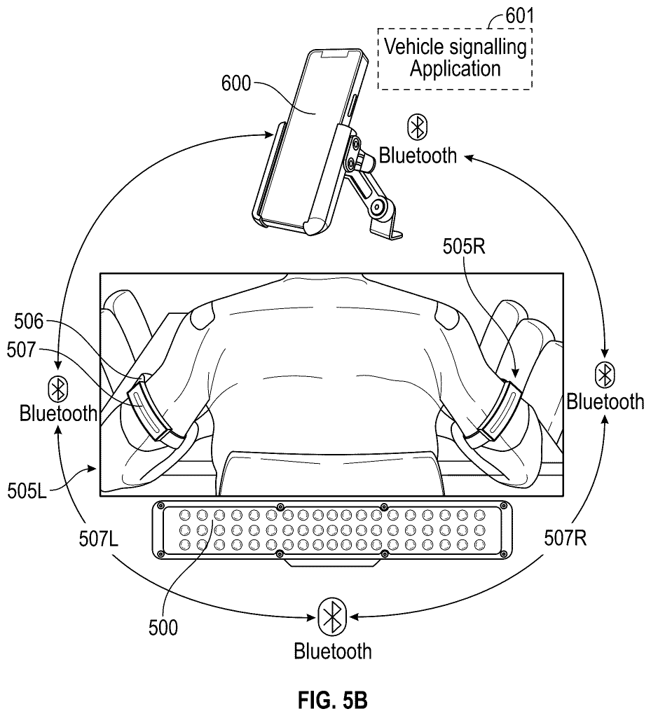

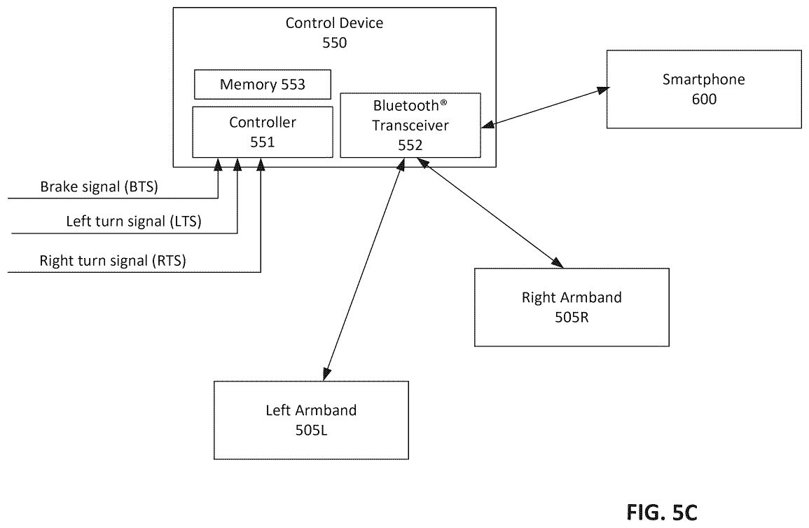

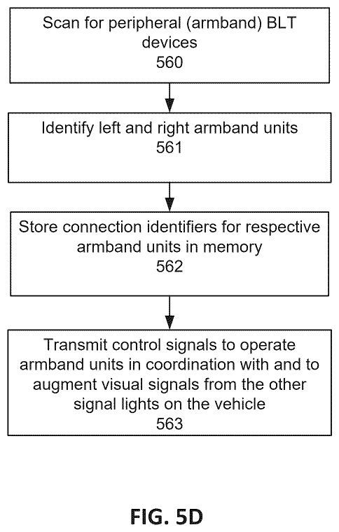

FIG. 5A illustrates an example of additional vehicle safety lighting provided on armbands to be worn by an operator of a vehicle, such as a motorcycle or scooter, according to principles described herein. In other examples, however, the LEAs of the armbands, as described herein, could be disposed on clothing for the vehicle operator. For example, the LEAs could be disposed on the sleeves of a jacket or on pants worn by the rider.

As shown in FIG. 5A, a lightbar 500 has been added to a vehicle, such as a motorcycle or scooter. This lightbar 500 may be an example of the lightbar 100 and supporting system described above in FIGS. 1-4. The lightbar 500 may be in addition to the original turn signals 501 and brake light 502 that were built into the vehicle by the original manufacturer.

The lightbar 500 will be in communication with the signaling system of the vehicle and controlled so as to light up for giving visual signals that coordinate with those of the original turn signal lights 501 and brake light 502 of the vehicle. In some examples, the lightbar 500 may also provide signals for deceleration from other causes than operation of the vehicle brakes, as described above.

In the example of FIG. 5A, the vehicle operator is also provided with two armbands 505, one to be worn on each arm as shown. Each armband 505 includes an arm strap 506 to secure the armband around the operator's arm and an array of light emitting elements, referred to as a Light Emitting Array (LEA) 507. Similar to the description of the lightbar 100 given above, each LEA 507 has a support substrate supporting an array of light emitting elements, e.g., LEDs, mounted on a support surface of the substrate.

Each of the armbands 505 will have a wireless communication link 508 with the lightbar 500 or with another control unit as will be described in more detail below. Through this wireless communication link 508, signals are sent to the armbands 505 to control the LEAs 507 to signal the operation of the vehicle in coordination with the lightbar 500, the original turn signal lights 501, and/or the original brake light 502. The additional visual signaling provided by the LEAs 507 makes the signal being sent more prominent and less likely to be overlooked or unseen by the operator of a nearby or trailing vehicle. Consequently, the safety of the operator wearing the armbands 505 is significantly enhanced, as is the safety of other drivers and bystanders.

The wireless communication links 508 may be Bluetooth® links or may use other wireless protocols. The links 508 may be between the armband units 505 and the lightbar 500 or another controller to operate the LEAs 507 appropriately. As used herein, Bluetooth® (BLT) is a technology standard using a Bluetooth® Low Energy (BLE) protocol. In particular, a Bluetooth® Mesh may provide the network and communications among the armbands and a control device that is signaling the armbands with information about the vehicle operation for which the armband is to provide corresponding visual signals.

Bluetooth® Mesh technology is an advancement in wireless communication that goes beyond traditional point-to-point connections. Unlike standard Bluetooth®, which typically supports one-to-one or one-to-many connections, Bluetooth® Mesh enables devices to form a network where each device can communicate with any other within the range. This Mesh topology opens up new possibilities for smart homes, industrial automation, and other Internet of Things (IoT) applications. Devices in a Bluetooth® Mesh network work together to relay messages, extending the reach and robustness of the network. Mesh networking operates on Bluetooth® Low Energy (LE) and is compatible with core specification version 4.0 and higher. Bluetooth® Mesh networking uses an underlying Bluetooth® LE 4.x or 5.0 stack, which supports broadcaster and observer roles, to both advertise and scan for advertising packets.

In a system such as that described here, for example, as shown in FIGS. 5A and 5B, a control device and each armband represent nodes in a Bluetooth® Mesh. The control device may detect a brake or turn signal that is operating the built-in signal lights of the vehicle or a lightbar 500. The control device, using the Bluetooth® Mesh, will transmit that information to the armbands so that the light arrays on the armbands are operated to provide the same visual signal (i.e., brake or turn signal) as the other signal lights of the vehicle.

FIG. 5B illustrates an example of a system supporting the vehicle safety light armbands of FIG. 5A according to principles described herein. As shown in FIG. 5B, a smartphone 600 with a Bluetooth® transceiver may also have installed a vehicle signaling application 601. This smartphone 600 becomes another node in the Bluetooth® Mesh. The application 601 will include a user interface that allows a user to configure the operation of the system, including pairing the armbands 505 and making an identification of an armband as left or right. This will be described in more detail below.

In older Bluetooth® technology, a central control device, which could be the lightbar 500, the smartphone 600 or another control unit, scans for and initiate connections to BLE peripheral devices that are advertising their presence. The BLE peripheral devices advertise their presence by transmitting signals on BLE advertising radio channels.

In the illustrated example of FIG. 5B, the role of the control device is added to the lightbar 500. Hence, the lightbar 500 will operate in a Bluetooth® Mesh that includes the armbands 505 and will concurrently maintain communication, via the Mesh, with both armbands 505. Specifically, the lightbar 500 maintains one control connection 507L to a left armband 505L, via the Bluetooth® Mesh; and a second control connection 507R to a right armband 505R, again via the Bluetooth® Mesh.

The lightbar 500 may also maintain a third BLE connection to the smartphone 600 and application 601. This connection is not mandatory for system operation. However, the application 601 may be used for system configuration.

For example, upon powerup of the vehicle and/or the lightbar 500, the lightbar 500 activates as a control device and begins scanning to join the Bluetooth® Mesh and determine if the armbands 505 are present, i.e., turned on and communicating within radio range of the lightbar 500. When scanning, the lightbar 500 or any other Bluetooth® Mesh device receives advertising packets from any other BLE device that is presently advertising in the vicinity.

In older Bluetooth® systems, the lightbar would act as a BLE central device and filter out the received advertising packet data to attempt to find packets associated with the left and right armbands 505. In this way, the BLE central device discovers and auto-manages connections to the two independent armband units. However, this management is unnecessary in a Bluetooth® Mesh environment.

The armbands 505 can identify themselves as left or right by using a unique BLE advertising name or Universal Unique Identifier (UUID). This information is presented in specific fields in the armbands' advertising BLE radio packets.

The setting of an armband 505 as being left or right can be done by various methods. For example, a setting in the hardware options on the printed circuit board (PCB) of an armband 505 can designate the armband as left or right during manufacture. In another example, the firmware in an armband can be programmed to designate the band as left or right. Lastly, when pairing with the system, for example using the application 601, an armband 505 can be designated as left or right.

In some examples, the control device 550 will not accept pairing with an armband except with the assistance of the application 601 on the smartphone 600. This prevents the control device 550 from pairing with an armband owned by another operator and can impose the requirement that any armband paired to the system has been designated as a left or right armband. Without this feature, the incorrect visual signal could be output by an erroneously paired armband that is not being worn where expected.

Once assigned as left or right, the armbands can advertise their presence on the Bluetooth® Mesh with corresponding names, such as “Armband Left” and “Armband Right.” Conversely, as an alternative to relying on a name, the band could advertise with a UUID that the control device 550 will recognize as belonging to a left or right armband. For example, the left armband 505L could advertise with a UUID 5ce50dca-98c2-40dc-b627-4528e6d20055, whereas a right armband 505R could advertise with a UUID 5de50dca-98c2-40dc-b627-4528e6d20055. The small difference between the two UUIDs is known to the control device 550 to distinguish between the left and right units.

When the control device 550 receives the advertising packet, the BLE subsystem will also measure/provide received radio signal strength (RSSI) at the moment the advertising packet was received. This is typically expressed in dBm. A higher number is a stronger radio frequency RSSI signal. In the scenario where there could be multiple left/right armbands within radio range, the control device, e.g., lightbar 500, can make decisions on which left/right armbands 505 it will connect with based on which provides the strongest RSSI signal. This should provide connection to the armbands closest to the control device which, presumably, are the armbands on the operator of the vehicle. In the case of any ambiguity, the control device and pair with units most recent paired previously.

Once the control device, e.g., lightbar 500, has found a left and right armband advertising, the lightbar 500 will proceed to make BLE connections to those two armbands as peripheral devices per normal BLE connection procedures. The control device 550 will store a unique numerical BLE connection identifier for each of the left and right armbands 505. This is used later when sending BLE messages to the armbands 505. The BLE message is sent via a BLE connect identifier, and the control device 550 needs to remember which one is associated with the left or right armband.

After two armbands have been connected to a control device, a corresponding unique pair ID can then be stored so the two armbands are thereafter treated as a pair. This may also help RSSI ambiguities in the future. For example, if two vehicles close to each other power up at about the same time, with a rider on each of them, there could be some ambiguities in determining discovered armbands. The system will use a combination of RSSI and unique pair ID to sort out ambiguities where RSSI may not be sufficient. Where ambiguity cannot be resolved, the system can allow new pairings to occur and re-establish a new unique pair ID, e.g., in the case of a replacement unit.

As described above, the control device 550 will operate in coordination with the original turn and brake signal lights of the vehicle. Additionally, with the wireless links to the armbands, the control device 550 will send appropriate data messages to one or both armbands 505 to activate brake or turn signals using the LEAs 507 on the respective armbands 505. For example, if the lightbar 500 is turned on to indicate braking or deceleration, the LEAs 507 will likewise be activated to augment the signal that the vehicle is decelerating. If the lightbar 500 is flashing on the left or right side as a left or right turn signal, a corresponding signal will be sent only to the left or right armband so that the LEA 507 on that armband also blinks or flashes to augment the visual signal that the vehicle is turning, merging or entering/leaving traffic to that side.

An alternative explanation of this system is given with respect to FIGS. 5C and 5D. As shown in FIG. 5C, the system includes a control device 550. This device 550 may be incorporated into a lightbar, as in the example described above, or may be a unit independent of a lightbar or other device. The control device 550 includes a controller 551 that is programmed or configured to carry out the operations of, for example, FIG. 5D and the other subsequent flowcharts. The controller 551 is in communication with a memory 553 for storing firmware and operational data for the controller 551. The controller 551 is also in communication with a Bluetooth® transceiver 552.

As shown in FIG. 5C, the controller 551 of the control device 550 receives signals that indicate what the signaling system of the vehicle is doing. For example, the controller 551 receives, when active, a brake signal, a left turn signal or a right turn signal. These signals are coordinated with the signals in the native signaling system of the vehicle. The controller may be wired into or in wireless communication with the native signaling system of the vehicle. The native signaling system of the vehicle is the system built into the vehicle to operate the original turn signals 501 or brake light(s) 502 as shown, for example, in FIG. 5A. Upon receipt of any of these signals (brake, left turn, right turn), the controller 551 operates the BLT transceiver 552 to send a corresponding signal or signals to the left armband 505L and/or right armband 505R, as described above.

Further operation of the system of FIG. 5C is illustrated in the flowchart of FIG. 5D. As shown in FIG. 5D, when activated, the control device scans for peripheral devices 560 that are broadcasting their UUIDs. From among these signals, the central device identifies the left and right armband units 561 that it will control. In an initial pairing operation, this may include determining which armband units are in the closest proximity using signal strength, as described above. An initial pairing operation may also include inputting an identifier into the user interface of a smartphone application (as shown in FIG. 5B) to ensure that the correct control device and peripheral devices are paired. UUIDs or connection identifiers for the paired armband units are stored 562 in the memory of the control device. Thereafter, the control device will transmit control signals to operate 563 the armband units in coordination with and to augment the visual signals from the other signal lights on the vehicle.

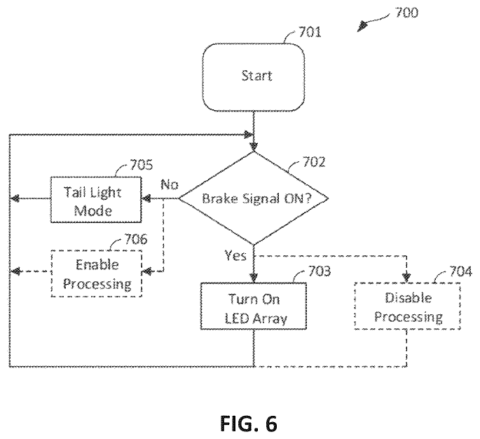

FIG. 6 is a flow diagram showing an exemplary flow 700 of operations for vehicle safety lighting that includes the armband units described above. The operation, according to the flow 700, can begin at an arbitrary start 701, for example, upon the vehicle operator starting the engine of the vehicle or, in the case of a plug-in hybrid or all electric vehicle, upon the operator initiating a vehicle departure. The flow 700 can proceed to 702 where the controller (e.g., 551, FIG. 5C) can determine whether the brake signal is activated. If the answer is “YES,” the flow 700 can proceed to 703 and activate, as a brake light of the vehicle, light emitting elements of an armband unit, e.g., both armband units. In various examples, operations at 703 can include the controller activating all of, or particular regions, areas, or patterns of the LEA 507, to notify drivers following the vehicle by a lighting pattern associated with application of the brakes. In various examples, the activated light emitting elements of the LEA 507 can include red light emitting elements. The activation can include, for example, generating the LEA activation signals at a particular PWM width to obtain a given brightness.

Continuing, the flow 700 can include a disabling, at 704, of processing for detecting a deceleration of the vehicle. Such disabling can include, for example, disabling a clock input to the controller, or to the above-described A/D converter, if separate from the controller. Alternatively, the disabling can include switching the controller (e.g., 551, FIG. 5C) to a “stand-by” or equivalent state. In contrast, if the controller determines that the brake signal is not activated (e.g., off or low), the red light emitting elements of the LEA may be off or in a low-brightness tail-light mode. From 703, or 703 and 704, the flow 700 can loop back to 702 where the controller can determine whether the brake signal is still activated. If the answer is “YES,” the above-described loop through 703, or 703 and 704, can repeat.

Still referring to FIG. 6, if the determination at 702 is that the brake signal is not activated, the flow can proceed to 705 and switch, for example, to a tail-light mode. The tail light mode can include the controller activating, for example, all of the LEA, or particular regions, areas, or patterns within the LEA at a given brightness associated with normal tail light operation. In some examples, operations at 705 can also switch off all energization of all light emitting elements in the LEA, for example, in response to a “lights off” mode of the vehicle. Also, application 601 in a smartphone 600 can include a user interface that allows the user to turn off any lighting of the armband LEAs, for example, to conserve battery power. In various examples, these actions result in the disabling at 704. Alternatively, the flow 700 can include, in association with a “NO” at 702, an enabling at 706 of deceleration detection processing. From 705, or 705 and 706, the flow 700 can loop back to 702 where the controller (e.g., 551, FIG. 5C) can determine whether the brake signal is being activated. If the answer is “NO,” the above-described loop through 705, or 705 and 706, can repeat. If the answer is “YES,” the flow 700 can perform the above-described loop through 703, or 703 and 704, then return to 702.

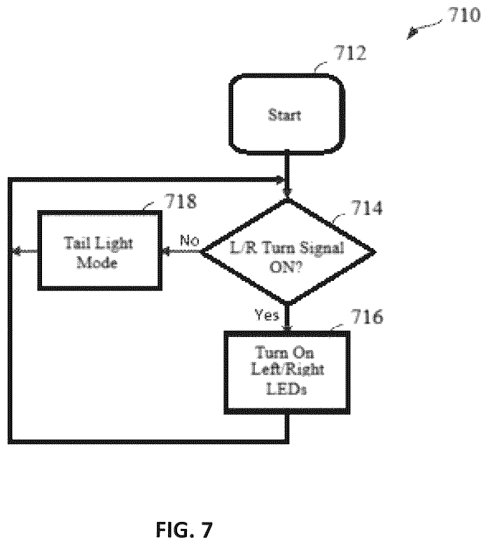

FIG. 7 is a flow diagram showing an exemplary flow 710 of operations in a process for vehicle safety lighting that includes an inter-operation with vehicle left-right turn signals, in an exemplary vehicle safety lighting system according to one or more aspects of the disclosure. Operation according to the flow 710 can begin at an arbitrary start 712 that can be, for example, the same as the above-described arbitrary start 701. The flow 710 can proceed to 714 where the controller (e.g., 551, FIG. 5C) can determine whether the left turn signal LTS or right turn signal RTS activated. If the answer is “YES” the flow 710 can proceed to 716 where the controller can activate amber light emitting elements of the array (e.g., LEA 507) of the corresponding armband 505. In some examples, operations at 716 can include activating amber light emitting elements within a region, area or pattern of the array located on the corresponding armband. If the answer is “NO” the flow 710 can proceed to 718, which is a tail light mode.

For example, corresponding to LTS, operations at 716 can include activating all of the amber light emitting elements of the left armband 505L, e.g., in a flashing or blinking mode. Likewise, corresponding to RTS, operations at 716 can include activating all of the amber light emitting elements of the right armband 505R, e.g., in a flashing or blinking mode.

In various examples, the controller 505 can be configured such that operations at 803 can include the controller, upon detecting the brake lights are active on an armband that is now to indicate a turn, deactivating the brake light located on that armband in favor of the activated turn light. For example, the left brake light (e.g., red light emitting elements of the left armband) may be deactivated or switched off when the left turn signal is on (e.g., if LTS is received), and the right brake light may be deactivated or turned off (e.g., red light emitting elements of right armband) if the right turn signal is on (e.g., RTS is received). Still referring to FIG. 7, the controller can be configured such that, upon determining at 802 that neither the left turn signal nor right turn signal is activated (e.g., off or low), the controller can switch the amber light emitting elements of the LEAs 507 to off or into a low-brightness tail-light mode.

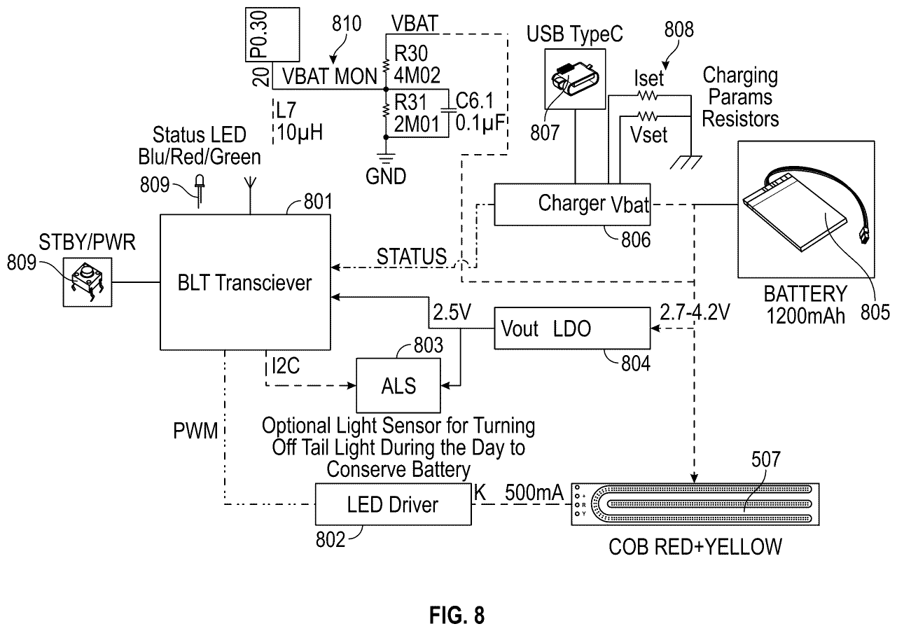

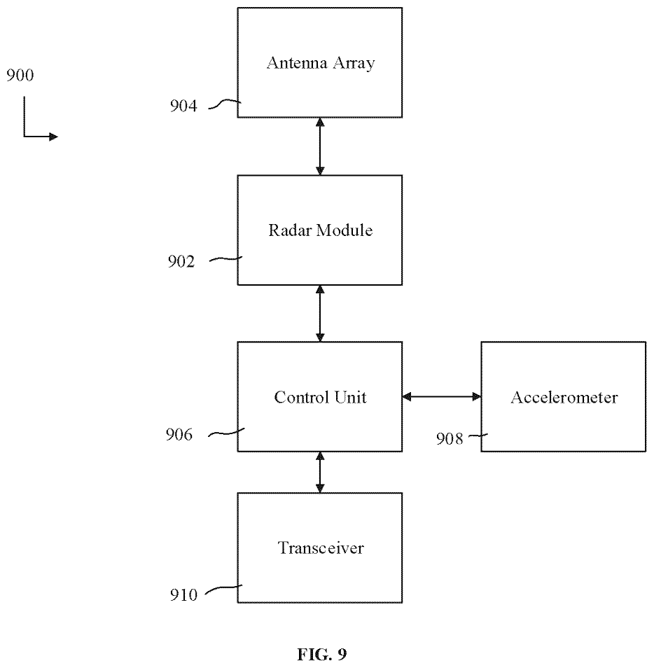

FIG. 8 illustrates the components of an example of an armband unit according to principles described herein. As shown in FIG. 8, an example of an armband unit may include the following. A BLT transceiver 801 receives control signals from the control device, as described above. Using pulse width modulation, as also described above, the control signal is sent to an LED driver 802 which operates the LEA 507, as described above. The BLT transceiver 801 may include a power/standby indicator 809 to indicate whether it is powered to receive control signals. The transceiver 801 may also include a status indicator 809 to indicate when a control signal is being received or a communication link with the control device has been made.

An ambient light sensor 803 can determine the amount of light in which the unit is operating. For example, if the unit is operating in bright sunlight, as determined by the ambient light sensor 803, the lightbar 507 may not be bright enough to provide helpful visual signals. In that case, the unit may be deactivated to conserve battery power. Alternatively, the ambient light sensor may indicate how brightly the LEA 507 should be operated in current conditions to provide an effective visual signal.

A battery 805 provides the power for the unit. A low dropout regulator (LDO) 804 may be connected between the battery 805 and the transceiver 801 to regulate an output voltage for the transceiver 801 powered from the higher-voltage input of the battery 805. The LDO may also connect the battery to the ambient light sensor 803. Lastly, the battery 805 also provides power to light the lightbar 507.

A charger 806 is provided to charge the battery 805. For example, the charger 806 may have a Universal Serial Bus (USB) port 807, e.g., USB type C. Through this port 807, power is provided to charge the battery 805. A number of charging parameter resistors 808 may be provided between the charger 806 and ground to help control proper charging of the battery 805.

Lastly, the example of an armband unit includes a battery monitor circuit 810. This circuit monitors the battery voltage of the battery 805. When the voltage of the battery 805 drops below a certain voltage threshold (that can be set in firmware), the armband unit will shut down. For example, the voltage threshold could be 2.75V. Resistors with relatively high resistor values are used in the circuit 810 to prevent the battery from discharging through the monitoring circuit 810.

FIG. 9 is an example of a rear-approach detection and warning subsystem 900. The rear-approach detection and warning subsystem 900 can be configured to identify a trailing vehicle that is approaching from behind the rider's vehicle to generate a corresponding rear alert signal for wireless transmission to one or more armbands or light bands worn by the rider. The rear-approach detection and warning subsystem 900 can include a radar module 902, antenna array 904, control unit 906, accelerometer 908, and transceiver 910. The accelerometer 908, transceiver 910, and control unit 906 can be similar to those described with regard to FIGS. 1-8, and for the sake of brevity, are not further described here.

The radar module 902 can be coupled to the control unit 906. The radar module 902 can be a frequency-modulated continuous-wave (FMCW) millimeter-wave module in communication with the wireless control device via a microcontroller powered BLE module. The radar module 902 can be coupled to the antenna array 904 that includes at least one antenna mounted at or near the rear of the vehicle. The radar module 902 can be implemented at approximately 24 GHz or 60 GHz, and the antenna array 904 can include integrated patch antennas arranged to provide a center beam oriented rearward relative to the direction of travel. According to certain implementations, only the center beam may be used for sensing, thereby simplifying signal processing and minimizing false positives by focusing detection on objects aligned with the primary travel path of trailing vehicles. During operation, the radar module 902 can transmit continuous FMCW chirps and measure beat frequencies derived from reflected signals to estimate the relative velocity, distance, and rate of closure of a trailing vehicle. The radar output may be converted into Universal Asynchronous Receiver Transmitter (UART) formatted data, for example at approximately 19,200 baud, and communicated to the central Bluetooth module through a four-wire electrical interface. The radar output may be converted into Universal Asynchronous Receiver Transmitter (UART) formatted data, for example at approximately 115200 baud, and communicated to the central Bluetooth module through a four-wire electrical interface. The microcontroller of the wireless control device can poll this UART stream every few milliseconds, allowing for near-real-time detection of a fast-approaching vehicle or a following vehicle that is too close.

The microcontroller can further execute algorithms that fuse radar-derived approach vectors with additional situational information obtained from the accelerometer module 908. The accelerometer data may be used to determine rapid deceleration events, pitch or roll anomalies, or conditions indicative of a crash or motorcycle tip-over. By integrating the radar-based detection of approaching vehicles with accelerometer-based deceleration and stability metrics, the wireless control device may implement a composite threat-assessment algorithm that identifies when the rider is at elevated risk, such as when a vehicle is closing in too quickly from behind, when braking forces exceed predefined thresholds, or when the motorcycle is in an abnormal orientation. Based on identifying one or more of these conditions, the wireless control device can generate a rear alert signal configured to instruct at least one armband or wearable light band via the transceiver 910 to illuminate in a preselected pattern. In exemplary implementations, the rear alert signal may encode a command to activate red or amber warning segments of the armband in a flashing, strobing, or wig-wag pattern to visually warn the approaching vehicle of the potential hazard.

Each armband can include a wireless receiver configured to receive the rear alert signal from the central BLE module and to produce a corresponding visual alert through integrated light-emitting elements. In certain embodiments, the armband incorporates a microcontroller, a BLE transceiver, and a plurality of LEDs arranged to provide high-visibility light output in multiple directions around the rider's arm. The armband may be configured to respond only to authenticated or paired signals from the wireless control device, ensuring reliable and interference-resistant operation. Upon receiving the rear alert signal, the armband can drive its LED array to generate a predefined warning effect such as a rapid amber wig-wag, a high-intensity red flash, or a dual-color pattern that corresponds to the type and severity of the detected event. For example, a rapid red strobe may be triggered in response to a trailing vehicle approaching at an excessive rate of closure; a slower amber oscillation may correspond to a trailing vehicle that is following too closely; and a distinctly patterned wig-wag may indicate a crash or tip-over condition detected by the accelerometer subsystem. These visual effects can be configured to supplement or mirror the lighting patterns generated by a light bar or rear-mounted illumination device, thereby increasing the total light footprint presented to surrounding motorists and enhancing the rider's safety envelope.

In some implementations, the system is configured to maintain functionality both in conjunction with the motorcycle's electrical architecture and independently of it. The wireless control device, radar module, and accelerometer can receive power from the vehicle's electrical system during normal operation, but the BLE-based communication pathway and the self-powered armbands can continue operating even if the vehicle's electrical system is degraded, interrupted, or temporarily unavailable. This dual-mode operation enables the system to deliver rear-vehicle approach warnings under a range of operating conditions, including low-voltage scenarios, accessory-power outages, or situations where the motorcycle has come to rest following a collision. The capability to operate using both vehicle-integrated power and independent power stored within the wearable devices provides a level of redundancy that can enhance rider safety in circumstances where conventional brake-light signaling may be insufficient or compromised.

The placement of the radar module at the rear of the motorcycle, coupled with the four-wire connection to the control unit 906, allows installers to choose an optimal mounting location that offers unobstructed rearward visibility while accommodating the geometry of different motorcycle models. The integrated patch antennas of the radar module can provide that the rearward sensing beam remains consistent and mechanically stable once installed, reducing calibration requirements and improving detection reliability. By continuously monitoring the radar data stream, the wireless control device can track the movement and acceleration profile of vehicles behind the rider, classify threat levels, and issue the rear alert signal rapidly enough to provide trailing drivers with visual warnings that supplement brake-light illumination. When combined with the accelerometer-derived determination of rapid deceleration or motorcycle instability, the system can activate emergency amber wig-wag modes or other enhanced alert patterns specifically tailored to draw the attention of trailing motorists.

In one implementation, a proximity-based alert system can utilize an algorithm that can be executed by the wireless control device to cause the light bands to flash when a trailing vehicle is too close. The algorithm can include continuously receiving distance estimates from the FMCW radar module's center beam and maintains a filtered distance signal using a moving average or low-pass filter to suppress noise and transient spurious returns. The system can maintain one or more distance thresholds corresponding to different risk levels, for example a “caution” distance and a shorter “critical” distance. In some implementations, these thresholds can be pre-programmed, but also can be user-defined via a smartphone application. When the filtered distance drops below the caution threshold for longer than a minimum dwell time (e.g., 200-500 ms), the wireless control device can transition into a first alert state and generate a rear alert signal commanding the armbands to flash at a moderate frequency using an amber pattern, indicating to the driver behind that they are following too closely. If the filtered distance further drops below the critical threshold while remaining there for an additional dwell time, the algorithm escalates to a second alert state and transmits an updated rear alert signal that causes the armbands to emit a more aggressive pattern, such as high-intensity red strobes or fast amber wig-wag. Hysteresis can be applied so that the alert state is not cleared until the trailing vehicle has retreated beyond a higher “clear” threshold for a specified time, thereby preventing rapid toggling. In this way, the proximity-based algorithm provides graded visual warnings that scale with the severity of the following distance condition.

In another implementation, the system can utilize a closing-speed or approach-rate algorithm to trigger the light bands based on how quickly a trailing vehicle is approaching, even if it has not yet reached an unsafe absolute distance. The wireless control device can compute a relative velocity and/or time-to-collision (TTC) metric from successive radar measurements by tracking changes in range over time and evaluating Doppler-derived speed estimates. The algorithm may maintain a rolling buffer of recent range and speed data, from which it derives a smoothed closure rate. If the closure rate exceeds a configurable threshold (e.g., the trailing vehicle is gaining more than a specified meters-per-second on the rider) and the projected TTC falls below a predetermined time window, the wireless control device can generate a rear alert signal instructing the armbands to flash in a distinctive approach-warning pattern. For example, the bands may transition from a low-level steady glow to a rapidly increasing flash rate or a pulsating amber-red pattern as TTC decreases, thereby intuitively communicating the urgency of the situation to the driver behind. The algorithm can also incorporate accelerometer data from the motorcycle to identify when rapid deceleration by the rider coincides with a high closure rate from the rear, in which case the system can immediately invoke an emergency wig-wag mode without waiting for additional samples. Once the closure rate and TTC return to safe ranges for a sustained period, the system can smoothly revert the armbands to a non-alert or lower-intensity state to avoid driver desensitization.

In some implementations, the rear-approach detection subsystem can utilize one or more radar sensing modalities selected to balance field-of-view coverage, detection accuracy, and signal discrimination for vehicles approaching from behind. Many FMCW radar modules suitable for motorcycle integration transmit a relatively wide beam pattern, for example on the order of approximately 100 degrees in the horizontal plane and approximately 40 degrees in the vertical plane. While such a beam provides robust coverage of the rearward environment, it may also capture returns from vehicles located in adjacent lanes or peripheral regions that are not directly relevant to a rear-end collision risk. Accordingly, when FMCW radar modules are used, the wireless control device can apply digital filtering, angular gating, and motion-based classification algorithms to discriminate rear-approaching vehicles from side-lane traffic. These filtering techniques can include rejecting targets whose relative motion vectors do not substantially align with the longitudinal axis of the motorcycle, suppressing detections with low closing velocity, or weighting detections based on persistence within a central rearward region over multiple radar frames. In some implementations, digital filtering algorithms can be applied to raw radar returns or derived range/velocity estimates to suppress noise and irrelevant targets. These digital filtering algorithms can include low pass filtering, moving avering filtering, exponential moving average filtering, Kalman filtering, extended Kalman filtering, clutter suppression, alpha-beta filtering, alpha-beta-gamma filtering, and combinations thereof. In some implementations, the angular gating algorithms can include angular windowing (azimuth/elevation gating), region-of-interest gating, probabilistic angular weighting, sector-based target suppression, beam selection/masking, and combinations thereof. In some implementations, the motion-based classification algorithms can include relative velocity thresholding, time to collision estimation, longitudinal vs lateral velocity decomposition, track consistency/persistence filtering, trajectory projection and alignment estimation, constant bearing-decreasing range calculation, and combinations thereof. Thereby the system can effectively leverage the wide beam of an FMCW radar while substantially eliminating false alerts caused by vehicles traveling alongside the motorcycle.

In some implementations, the rear-approach detection subsystem can utilize pulsed blind-spot-detection (BSD)-type radar modules that can generate multiple discrete beams from the antenna array, such as a central rearward beam flanked by two lateral side lobes. These multi-beam radars provide inherent spatial separation between rearward and side detections, enabling the wireless control device to preferentially process signals from the central beam while ignoring or down-weighting returns from the side beams. These implementations can simplify rear-vehicle discrimination and reduce computational overhead associated with angular filtering. However, such pulsed radar modules may be less effective at detecting stationary objects or vehicles with minimal relative motion. For this reason, the system architecture is not limited to a single radar type, and different radar modalities may be evaluated or combined during development and deployment to achieve desired performance characteristics under real-world riding conditions. The detection ranges and alert thresholds of the system can be configured based on the selected radar modality and the operating context of the motorcycle. In exemplary implementations, the system is configured to detect fast-approaching vehicles from a minimum distance of approximately 12 meters to a maximum distance of approximately 60 meters, allowing sufficient time to generate visual warnings before a dangerous closing scenario develops. When FMCW radar is employed, the system may additionally support detection at much shorter ranges, for example less than approximately 2 meters, to identify vehicles that stop too close behind the motorcycle at traffic lights, on inclines, or on ramps where rearward vehicle encroachment and motorcycle back-rolling during gear shifting can pose a hazard. As a detected vehicle crosses successive distance, velocity, or time-to-collision thresholds, the wireless control device can issue rear alert signals in graduated increments, each associated with a distinctive light pattern, intensity, or flash rate on the armbands or other warning lights. This multi-threshold approach provides intuitive, escalating visual cues to trailing drivers while minimizing unnecessary alerts and enhancing overall safety.

In the foregoing detailed description, numerous specific details were set forth by way of examples in order to provide a thorough understanding of the relevant teachings. It will be apparent to persons of ordinary skill, upon reading the description, that various aspects can be practiced without such details. In other instances, well known methods, procedures, components, and/or circuitry have been described at a relatively high-level, without detail, in order to avoid unnecessarily obscuring aspects of the present teachings.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows, and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein.

Relational terms such as first and second and the like may be used solely to distinguish one entity or action from another without necessarily requiring or implying any actual such relationship or order between such entities or actions. The terms “comprises,” “comprising,” and any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “a” or “an” does not, without further constraints, preclude the existence of additional identical elements in the process, method, article, or apparatus that comprises the element. Furthermore, subsequent limitations referring back to “said element” or “the element” performing certain functions signifies that “said element” or “the element” alone or in combination with additional identical elements in the process, method, article or apparatus are capable of performing all of the recited functions.

The Abstract of the Disclosure is provided to allow the reader to quickly identify the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that any claim requires more features than the claim expressly recites. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A vehicle safety lighting system comprising:
a wireless control device including a controller and a first wireless transceiver, the wireless control device configured to receive brake, left and right turn signals from a vehicle; and
left and right armbands for an operator of the vehicle, each armband including a Light Emitting Array (LEA) and a second wireless transceiver set, wherein the second wireless transceiver set is configured to communicate with the first wireless transceiver, wherein:
each armband is configured to be designated by a user as left or right,
each armband is configured to receive a control signal from the wireless control device, the control signal causing the LEA of the armband to output a visual signal coordinated with the brake, left or right turn signals of the vehicle,
at least one armband is configured to receive a rear alert signal from the wireless control device and produce an alert light based on receiving the rear alert signal, and the wireless control device generates the rear alert signal based on detection of a trailing vehicle approaching a rear of the vehicle.

2. The system of claim 1, wherein the wireless control device is a Bluetooth® control device.

3. The system of claim 1, wherein:
the wireless control device is incorporated into a light bar mounted on the vehicle, and
a unique pair ID is stored in the left and right armbands so that the system identifies the left and right armbands as a coordinated left-right pair.

4. The system of claim 1, wherein each armband light bar comprises light emitting devices of multiple colors.

5. The system of claim 1, wherein the wireless control device comprises a memory to store a Universal Unique Identifier (UUID) for each armband.

6. The system of claim 5, wherein the UUID for each armband includes a designation of left or right for each armband.

7. The system of claim 1, wherein the wireless control device comprises a memory to store a left or right designation for each armband paired with the wireless control device.

8. The system of claim 1, wherein the wireless control device comprises a memory to store a unique pair identifier for a pair of armbands previously connected to the wireless control device.

9. The system of claim 1, further comprising a smartphone application, the application comprising a user interface to facilitate pairing of the armbands with the wireless control device.

10. The system of claim 9, wherein the user interface of the application is configured to receive designation of one of the armbands as the right or left armband.

11. A method of vehicle safety lighting, the method comprising:
receiving, via a wireless control device, brake, left and right turn signals from a vehicle, the wireless control device comprising a controller and first wireless transceiver;
transmitting, via the wireless control device, a control signal to each of left and right armbands worn by an operator of the vehicle, each armband comprising a Light Emitting Array (LEA) and a second wireless transceiver set, wherein the second wireless transceiver set is configured to communicate with the first wireless transceiver, wherein each armband is configured to be designated by a user as left or right; and
outputting, based on the control signal, a visual signal with the LEAs, wherein the visual signal is coordinated with the brake, left or right turn signals of the vehicle,
wherein at least one armband is configured to receive a rear alert signal from the wireless control device, wherein the at least one armband is configured to produce an alert light based on receiving the rear alert signal, wherein the wireless control device generates the rear alert signal based on detection of a trailing vehicle approach to the rear of the vehicle.

12. The method of claim 11, wherein the wireless control device is a Bluetooth® control device.

13. The method of claim 11, wherein the wireless control device is incorporated into a lightbar mounted on the vehicle.

14. The method of claim 11, wherein each armband identifies itself to the wireless control device with a Universal Unique Identifier (UUID).

15. The method of claim 14, wherein the UUID for each armband includes a designation of left or right for each armband.

16. The method of claim 11, further comprising, storing, via the wireless control device, a left or right designation for each armband paired with the wireless control device; and activating the brake visual signal based on detection of vehicle deceleration above a brake light activation threshold.

17. The method of claim 11, further comprising, storing, via the wireless control device a unique pair identifier for a pair of armbands previously connected to the wireless control device.

18. The method of claim 11, further comprising, using radio signal strength (RSSI) to distinguish between armbands to be connected to the wireless control device; and determining, based on RSSI received from a plurality of prospective armband sets, which set to pair.

19. The method of claim 11, further comprising, controlling pairing of the armbands with the wireless control device via a smartphone application.

20. A vehicle safety lighting system comprising:
a Bluetooth® control device comprising a controller and Bluetooth® first wireless transceiver, the Bluetooth® control device configured to receive brake, left and right turn signals from a vehicle; and
left and right armbands for an operator of the vehicle, each armband comprising a Light Emitting Array (LEA) and a second Bluetooth® wireless transceiver set, wherein the second wireless transceiver set is configured to communicate with the first wireless transceiver,
wherein each armband is configured to be designated by a user as left or right; and
wherein the LEA is configured to receive a control signal from the Bluetooth® wireless control device, the control signal causing the LEA to output a visual signal coordinated with the brake, left or right turn signals of the vehicle, and wherein at least one armband is configured to receive a rear alert signal from the wireless control device, wherein the at least one armband is configured to produce an alert light based on receiving the rear alert signal, wherein the wireless control device generates the rear alert signal based on detection of a trailing vehicle approach to a rear of the vehicle.
